(19) United States
(12) Patent Application Publication
(10) Pub. No.: US 2011/0190946 A1
(43) Pub. Date: Aug. 4, 2011

(54) Method And System Of Energy-Efficient Control For Central Chiller Plant Systems

(76) Inventors: Charles Ho Yuen Wong, Shanghai (CN); Gang Wu, Shanghai (CN); Willis Wai Yin Wong, Shanghai (CN)

(21) Appl. No.: 13/060,005

(22) PCT Filed: Aug. 14, 2009
(86) PCT No.: PCT/CN2009/073253

§ 371 Date: Mar. 14, 2011

(30) Foreign Application Priority Data
Aug. 22, 2008 (CN) 200810041968.3

(51) Int. Cl. G05D 23/19; G06F 1/28

(52) U.S. Cl. 700/277

(57) ABSTRACT

A method of energy-efficient control for central chiller plant systems includes the following steps: collecting performance characteristics of each piece of equipment in central chiller plant systems and establishing energy models for each piece of equipment in central chiller plant systems and establishing energy models for each piece of equipment according to performance characteristics; sampling, with a predetermined time interval, actual cooling load of central chiller plant systems, computing optimized system working conditions based on actual cooling load and energy models of each piece of equipment, wherein optimized system working conditions ensure the least global energy consumption of all of equipment in central chiller plant systems; adjusting working conditions for each piece of equipment according to optimized system working conditions; and repeating steps of collecting, sampling and adjusting. An energy-efficient control system for central chiller plant system is also disclosed.

### FIELD OF THE INVENTION

Embodiments of the present invention relate to control techniques of central chiller plant systems, more particularly, relate to control techniques of energy efficiency for central chiller plant systems.

### BACKGROUND

A central chiller plant system operation includes: Chillers produce chilled water with predetermined temperature. Chilled water is transported to air terminals through chilled water pumps, to conduct thermal exchange with indoor air and remove its heat and moisture. Chilled water temperature increases after absorbing indoor heat. Heated chilled water is cooled again by chillers for recirculation. Heat generated by chillers during operation, including heat gain from indoor air exchanged by chilled water, heat generated by a compressor of water chillers, and heat chiller electrical components generate during operation, is removed by condenser water. Condenser water is transported to cooling towers through condenser water pumps to fulfill thermal and moisture exchange with outdoor air by dissipating heat and moisture into atmosphere.

Efficiency of chillers is affected by various factors. The efficiency of chillers may be regarded as a function of a plurality of factors. They mainly include: chiller cooling capacity, entering/leaving temperature of chilled water (or evaporating pressure of chillers), entering/leaving temperature of cooling towers, entering/leaving temperature of condenser water (or condensing pressure of chillers), etc. Generally speaking, relationship between these factors and the efficiency of chillers is:

The maximum efficiency of chillers occurs within the range of 45%˜75% of a rated cooling capacity of chillers.

The efficiency of chillers increases when leaving chilled water temperature increases.

Within a particular range, the efficiency of chillers increases when entering condenser water temperature decreases.

Power of centrifugal pumps is a function of its flow rate, generally, the maximum efficiency of the centrifugal pump happens within 75%˜90% of rated flow rate.

Efficiency of centrifugal pumps is also affected by distribution modes (constant-pressure or non constant-pressure water distribution) and rotation speed of pumps.

Based on above description, it can be concluded that, different configurations of chiller plant equipment all satisfy same system cooling load. For example, when a chiller plant system may operate with lower chilled water temperature and flow rate, it leads to higher energy use for chillers but lower for chilled water pumps. Alternately, higher chilled water temperature and flow rate leads to reverse energy performance of chiller and pump operation. In similar pattern, chillers may run under different parameters to achieve same cooling output but with different efficiency. For example, chillers may operate under lower condensing pressure with lower power, but condenser water pumps need to operate with higher power because the lower condensing pressure needs higher condenser water flow rate. Reversely, chillers operate under higher condensing pressure with higher power while condenser water pumps operate under lower flow rate with lower power.

When a group of chillers operate in parallel, many more possible configurations exist. For the same cooling load, a number of chillers may operate simultaneously while each chiller runs under lower part-load conditions, alternately only fewer chillers are active while each chiller runs under higher part-load or nearly full load conditions. It is also possible that chillers, chilled water pumps, cooling water pumps, and cooling towers do not operate in dedicated patterns.

Chillers, chilled water pumps, and condenser water pumps all have their own best efficiency point but when they work together as a system during actual operation, they cannot achieve their best efficiency simultaneously. Temperature and flow rate of chilled and condenser water may vary within a particular range without unsatisfying cooling load demand. Therefore, it is possible to optimize the global efficiency of central chiller plant systems by adjusting working conditions of each piece of equipment such as chiller cooling capacity, chilled water temperature and flow rate, entering/leaving condensing water temperature, and operating status of cooling towers.

### SUMMARY

Embodiments of the present invention provide the method and system for optimizing global energy efficiency of central chiller plant systems.

According to embodiments of the present invention, the method of energy-efficient control for central chiller plant systems is provided. The method includes:

collecting performance characteristics of each piece of equipment in a central chiller plant system and establishing energy models for each piece of equipment according to their performance characteristics;

sampling, with a predetermined time interval, actual cooling load of central air conditioning systems, to compute optimized system working conditions based on actual cooling load and energy models of each piece of equipment, wherein the optimized system working conditions ensure the best global energy efficiency of all of equipment in chiller plant systems;

adjusting working conditions for each piece of equipment according to the optimized system working conditions;

repeating steps of collecting, sampling, and adjusting.

According to an embodiment, a chiller plant system includes a group of chillers, wherein equipment performance data collected for water chillers includes:

supply chilled water temperature, t_{chws};

entering condenser water temperature of water-cooled chillers or outdoor air dry bulb temperature for air-cooled chillers, t_{cws/oat};

chiller cooling capacity, Q; rated capacity of chillers under typical evaporating and condensing temperature, Q_{ref};

input power under typical evaporating and condensing temperature, P_{ref};

energy models of chillers are established using regression based on their performance curves, including:

establishing a first function based on t_{chws} and t_{cws/oat};

establishing a second function based on t_{chws} and t_{cws/oa};

establishing a fourth function based on Q, Q_{ref} and the first function;

establishing a third function based on the fourth function;

establishing input power of chillers P as:

P=P_{ref}×the first function×the second function×the third function.

According to an embodiment, a chiller plant system includes a group of condenser water pumps, wherein equipment performance data collected for condenser water pumps includes:

condenser water flow rate, Q_{cw};

energy models of condenser water pump are established based on assumption that no flow modulating valves are provided to condenser water pipes. The energy model of condenser water pumps are established by:

Acquiring condenser water pump power by using condenser water flow rate as an independent variable;

Acquiring condenser water pump power correction value by using f condenser water low rate as an independent variable;

Acquiring condenser water pump power W_{cwe} as:

W_{cwe}=condenser water pump power×condenser water pump power correction value.

According to an embodiment, a chiller plant system includes a group of chilled water pumps, equipment performance data collected for chilled water pumps includes:

chilled water flow rate, Q_{chw};

energy models of chilled water pumps are obtained based on assumption that chilled water pumps are VSD-controlled according to differential pressure signals from differential pressure sensors that are installed between main supply and return chilled water pipes. The energy models of chilled water pumps are established by:

acquiring chilled water pump power by using chilled water flow rate as an independent variable;

acquiring chilled water pump power correction value by using chilled water flow rate as an independent variable;

acquiring chilled water pump power W_{chwe} as:

W_{chwe}=chilled water pump power×chilled water pump power correction value.

According to an embodiment, a chiller plant system includes a cooling tower, equipment performance data collected for the cooling tower includes:

rated input power of cooling tower fans, P;

energy models of cooling tower fans is established by:

acquiring power of cooling tower fans by using rated input power of cooling tower fans as an independent variable;

acquiring correction value of cooling tower fan power by using rated input power of cooling tower fans as an independent variable;

acquiring actual power of cooling tower fans W_{tower} as:

W_{tower}=power of cooling tower fans×correction value of cooling tower fan input power;

wherein the method further includes establishing performance models of cooling towers based on the following assumptions:

1) air and water vapor being ideal gas;

2) the cooling tower inlet flow rate equaling to outlet flow rate;

3) heat generated by cooling tower fans being ignored;

4) air films contacting water vapor being saturated;

5) ratio of thermal mass transfer coefficients—Lewis coefficient being 1;

wherein establishing performance models of cooling towers includes: performing off-line computation for cooling tower performance models, including:
collecting basic cooling tower parameters, such as outdoor wet bulb temperature t_{wbin0} under rated conditions, cooling tower condenser water entering temperature t_{win0} under rated conditions, cooling tower condenser water leaving temperature t_{wout0} under rated conditions, cooling tower heat extraction rate P_{tower0} under rated conditions, cooling tower airflow rate Mₐ₀ under rated conditions, cooling tower flow rate M_{w0} under rated conditions;
computing cooling tower heat transfer based on basic parameters of cooling towers;
acquiring operating parameters under different conditions by off-line computation, wherein operating parameters includes cooling tower condenser water entering temperature t_{win0}, cooling tower condenser water leaving temperature t_{wout0}, cooling tower heat extraction rate P_{tower0}, cooling tower airflow rate Mₐ₀, cooling tower flow rate M_{w0};
establishing cooling tower performance models for on-line computation; performing on-line computation, including:
computing, by using cooling tower performance models acquired by off-line computation, entering temperature t_{win} and condenser water flow rate M_{w} for a single cooling tower under current working condition based on heat extraction load of a single cooling tower Pₜᵢ, leaving temperature t_{wout}, and outdoor wet bulb temperature, t_{wbin0}.

According to an embodiment of the present invention, an energy-efficient control system for central chilled water system is provided, the system comprises:

a central PC, configured to collect performance characteristics of each piece of equipment in a central chiller plant system;

a plurality of Programmable Logic Controllers (PLCs), each connected to one or more groups of equipment in the central chiller plant system, are configured to control connected equipment. PLCs are connected to the central PC via industrial Ethernet;

energy modeling, configured to establish energy models for each piece of equipment according to their performance characteristics and to store energy models in model database;

wherein the central PC is configured to sample actual cooling load of a central chiller plant system with a predetermined time interval, compute optimized system working conditions based on actual cooling load and energy models of each piece of equipment stored in the model database, wherein the optimized system working conditions ensure the lowest overall energy consumption of all equipment in the central chiller plant system;

wherein each PLC is configured to adjust working conditions for equipment controlled by the PLC in accordance with the optimized system working conditions.

According to an embodiment, energy modeling is configured to establish energy models of chillers, whose performance characteristics collected by the central PC contains:

chilled water supply temperature, t_{chws};

entering condenser water temperature of water-cooled chillers or outdoor dry bulb temperature of air-cooled chillers, t_{cws/oat};

chiller cooling capacity, Q; rated capacity of chillers under typical evaporating and condensing temperature, Q_{ref};

input power under typical evaporating and condensing temperature, P_{ref};

energy modeling is configured to establish energy models of chillers by regression computation based on performance characteristics, containing:

acquiring a first function based on t_{chws} and t_{cws/oat};

acquiring a second function based on t_{chws} and t_{cws/oa};

acquiring a fourth function based on Q, Q_{ref} and the first function;

acquiring a third function based on the fourth function;

acquiring an input power of chillers P as:

P=P_{ref}×the first function×the second function×the third function.

According to an embodiment, the energy modeling is configured to establish energy models of condenser water pumps, whose performance characteristics collected by the central PC contains:

condenser water flow rate, Q_{cw};

energy modeling is configured to establish energy models of condenser water pumps based on assumption that no modulating valves are provided to condenser water pipes, containing:

acquiring condenser water pump power by using condenser water flow rate as an independent variable;

acquiring correction value of condenser water pump power by using condenser water flow rate as an independent variable;

acquiring power of the cooling water pump W_{cwe} as:

W_{cwe}=condenser water pump power×correction value of condenser water pump power.

According to an embodiment, energy modeling is configured to establish energy models of chilled water pumps, whose performance characteristics collected by the central PC comprises of:

chilled water flow rate, Q_{chw};

energy modeling is configured to establish energy models of chilled water pumps based on an assumption that chilled water pumps are VSD-controlled by differential pressure (DP) signals from DP sensors that are mounted between main supply and return chilled water pipes. The establishment comprises:

acquiring chilled water pump power by using chilled water flow rate as an independent variable;

acquiring correction value of chilled water pump power by using chilled water flow rate as an independent variable;

acquiring power of chilled water pumps W_{chwe} as:

W_{chwe}=chilled water pump power×correction value of chilled water pump power.

According to an embodiment, the energy modeling is configured to establish energy models of cooling tower fans, whose performance characteristics collected by the central computer comprises:

rated input power for cooling tower fans, P;

energy modeling is configured to establish energy models of cooling towers, comprising:

acquiring cooling tower fan power by using rated input power cooling tower fans as an independent variable;

acquiring correction value of cooling tower fan power by using rated input power of cooling tower fans as an independent variable;

acquiring actual power cooling tower fans W_{tower} as:

W_{tower}=power cooling tower fans×correction value of cooling tower fan power;

wherein the modeling is further contains configured to establish performance models of cooling towers based on the following assumptions:

1) air and water vapor being ideal gas;

2) the cooling tower inlet flow rate equaling to outlet flow rate;

3) heat generated by cooling tower fans being ignored;

4) air films contacting water vapor being saturated;

5) ratio of thermal mass transfer coefficients—Lewis coefficient being 1;

wherein establishing the performance models of cooling towers includes:

performing off-line computation for the cooling tower performance models, including:
collecting cooling tower basic parameters, such as outdoor wet bulb temperature t_{wbin0} under rated conditions, cooling tower condenser water entering temperature t_{win0} under rated conditions, cooling tower condenser water leaving temperature t_{wout0} under rated conditions, cooling tower heat extraction rate P_{tower0} under rated conditions, cooling tower airflow rate Mₐ₀ under rated conditions, cooling tower flow rate M_{w0} under rated conditions;
computing cooling tower heat transfer based on basic parameters of cooling towers;
acquiring operating parameters under different conditions by off-line computation, wherein the operating parameters includes cooling tower condenser water entering temperature t_{win0}, cooling tower condenser water leaving temperature t_{wout0}, cooling tower heat extraction rate P_{tower0}, cooling tower airflow rate Mₐ₀, cooling tower flow rate M_{w0};
establishing cooling tower performance models for on-line computation; performing on-line computation, including:
computing, by using cooling tower performance models acquired by off-line computation, entering temperature t_{win} and condenser water flow rate M_{w} for a single cooling tower under current working condition based on heat extraction load of a single cooling tower Pₜᵢ, leaving temperature t_{wout}, and outdoor wet bulb temperature, t_{wbin0}.

According to embodiments of the present invention, the global efficiency of central chiller plant systems is optimized by adjusting working conditions of each piece of equipment in consideration of such parameters as chiller capacity, chilled water temperature and flow rate, entering condenser water temperature, and cooling tower working conditions.

### BRIEF DESCRIPTION OF THE DRAWING(S)

The above or other features, natures or advantages of the present invention will be more obvious to skilled persons in the art by the following descriptions of the embodiments accompanying with the drawings, the same sign reference indicates the identical features throughout the description, and wherein:

FIG. 1 illustrates a flowchart of methodology of the energy efficiency control system for central chiller plant systems according to an embodiment of the present invention;

FIG. 2 illustrates a structural diagram of the energy efficiency control system for central chiller plant systems according to an embodiment of the present invention.

### DETAILED DESCRIPTION

Because all equipment in central chiller plant systems runs continuously, and cooling load and weather data vary time to time, it is impossible to achieve working conditions with of the best global efficiency of central chiller plant systems by experiments in which operating parameters of each piece of equipment varies individually. According to the concept of the embodiments of the present invention, mathematical models of relationship between energy consumption and equipment operating parameters in chiller plant systems are established first. Then, simulation is performed for energy consumption of chiller plant systems in response to different combinations of parameters such as equipment operating parameters within reasonable ranges, real time cooling load and weather data. A combination of parameters that result in the lowest energy consumption is selected from simulation results. Working conditions of each piece of equipment are adjusted in accordance with the selected combination of parameters, so that the lowest total energy consumption of chiller plant systems is achieved in full satisfaction of cooling load demand.

According to embodiments of the present invention, a control system is built on the basis of two-layer architecture. The upper layer comprises a central PC that is configured to perform global control philosophy and monitor operating conditions of chiller plant systems, while the lower layer are based on PLCs configured to control operations of equipment connected to PLCs. The central PC and the PLCs communicate with each other through industrial Ethernet. The global control philosophy is: to establish energy models for each piece of equipment in central chiller plant systems based on equipment performance characteristics, then establish global energy models for the whole chiller plant system based on energy models for each piece of equipment. When a chiller plant system runs, the central PC collects real-time cooling load with a predetermined time interval and performs simulation based on the cooling load, in search for working conditions that correspond to the lowest global energy consumption (the highest global energy efficiency) of the chiller plant system when the particular cooling load is satisfied. Based on these working conditions, the central PC determines values for each variable and sends them to corresponding PLCs. PLCs in turn control connected equipment, so that each piece of equipment in chiller plant systems operates in a manner in which the whole chiller plant system operates under the highest efficiency.

In the control philosophy, optimization is the core. From perspective of a control system, the optimization is a “set-point generator”. All of real-time operating parameters (determined values of control parameters) of equipment in central chiller plant systems are determined by the optimization. PLCs control equipment in accordance with the determined values. The control philosophy is an open-loop control for the whole chiller plant system, but is a close-loop control for each piece of equipment. Since equipment is controlled in group, a plurality of PLC sub-nodes will be configured. The plurality of PLC sub-nodes perform data collection, operation control, and failure alert for individual equipment in central chiller plant systems, including chilled water pumps, chillers, condenser water pumps, and cooling towers. A central PC uses TCP/IP protocol to communicate with PLCs. PLCs are connected to data interface of chillers by Modbus, and are connected, by standard analog signals (0-10V/4-20 mA), to other equipment, such as chilled water pumps, condenser water pumps, and cooling towers.

Mathematical models involved in the optimization include: energy models of chillers, energy models of condenser water pumps, energy models of chilled water pumps, performance models of cooling towers, and energy models of cooling tower fans. In these models, the energy model of chillers is a regression model, which is built with parameters necessarily acquired by ingress computation based on original data from chiller manufacturers. The energy model of condenser water pumps, chilled water pumps, and cooling tower fans are physical models with field correction functions. The performance model of cooling towers is a simplified physical model combined with a regression model, which is established with data under different working conditions generated through iterative computation based on sample data. Then the mathematical performance model is established through regression methods.

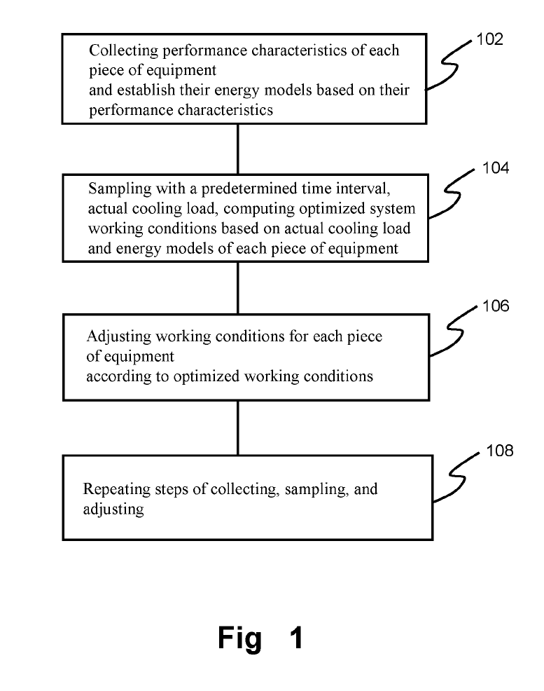

FIG. 1 illustrates a flowchart of the method of energy-efficient control for chiller plant systems according to an embodiment of the present invention, the method includes:

102. collecting performance characteristics of each piece of equipment in a chiller plant system and establishing energy models for each piece of equipment according to the performance characteristics;

104. sampling, with a predetermined time interval, actual cooling load of central chiller plant systems, computing optimized system working conditions based on actual cooling load and energy models of each piece of equipment, wherein the optimized system working conditions ensure the lowest global energy consumption of all of equipment in central chiller plant systems;

106. adjusting working conditions for each piece of equipment according to optimized system working conditions;

108. repeating steps of collecting, sampling and adjusting.

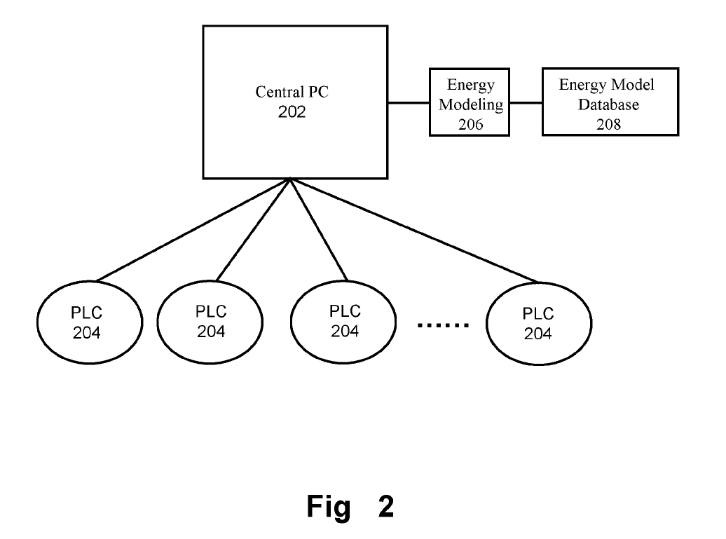

FIG. 2 illustrates a structural diagram of the energy-efficient control system for central chiller plant systems according to an embodiment of the present invention, the system includes:

a central PC 202, configured to collect performance characteristics of each piece of equipment in a central chiller plant system;

a plurality of PLCs 204, each connected to one or more groups of equipment in a central chiller plant system, PLCs configured to control working conditions of the connected equipment, PLCs connected to the central PC via industrial Ethernet;

energy modeling means 206, configured to establish energy models for each piece of equipment 202 according to performance characteristics and store energy models in energy model database 208;

wherein the central PC 202 is configured to sample an actual cooling load of central chiller plant systems with a predetermined time interval, compute optimized system working conditions based on actual cooling load and energy models of each piece of equipment stored in the energy model database 208, wherein optimized system working conditions ensure the lowest global energy consumption of all of equipment in a central chiller plant system;

wherein each of PLCs 204 is configured to adjust working conditions for equipment controlled by PLCs according to optimized system working conditions.

According to the embodiment shown in FIG. 2, a group of PLCs 204 are included, which are configured to control chillers, condenser water pumps, chilled water pumps, and cooling towers.

In the above method and system of energy-efficient control for central chiller plant systems, the following energy models are utilized:

### Chillers

Types of chillers are not limited. They can be centrifugal chillers, screw chillers, or even air-cooled chillers. Chiller energy models are regression models. Performance characteristics to be collected for chillers includes:

chilled water supply temperature, t_{chws};

entering condenser water temperature of water-cooled chillers, or outdoor air dry bulb temperature of air-cooled chillers, t_{cws/oat};

cooling capacity, Q; rated capacity of chillers under typical evaporating and condensing temperature, Q_{ref};

input power under typical evaporating and condensing temperature, P_{ref}.

Energy models of chillers are acquired by a regression computation based on performance characteristics, including:

Acquire a first function based on t_{chws} and t_{cws/oat}, the first function is noted as ƒ₁(t_{chws}, t_{cws/oat}), wherein ƒ₁(t_{chws}, t_{cws/oat}) is a polynomial about t_{chws} and t_{cws/oat}, wherein each item in the polynomial is composed of t_{chws}, t_{cws/oat}, an n-degree term of their combination, or a constant.

Acquire a second function based on t_{chws} and t_{cws/oa}, the second function is noted as ƒ₂(t_{chws}, t_{cws/oat}), wherein ƒ₂(t_{chws}, t_{cws/oat}) is a polynomial about t_{chws} and t_{cws/oat}, wherein each item in the polynomial is composed of t_{chws}, t_{cws/oat}, an n-degree term of their combination, or a constant.

Acquire a fourth function based on Q, Q_{ref} and the first function, the fourth function is noted as ƒ₄(Q, Q_{ref}, t_{chws}, t_{cws/oat}), wherein ƒ₄(Q, Q_{ref}, t_{chws}, t_{cws/oat}) represents a ratio between Q, Q_{ref} and the first function.

Acquire a third function based on the fourth function, the third function is noted as ƒ₃(ƒ₄(Q, Q_{ref}, t_{chws}, t_{cws/oat})).

Obtain an input power of chillers P as:

P=P_{ref}×the first function×the second function×the third function, denoted as: P=P_{ref}×ƒ₁(t_{chws}, t_{cws/oat})×ƒ₂(t_{chws}, t_{cws/oat})×ƒ₃(ƒ₄(Q, t_{chws}, t_{cws/oat}))∘

### Condenser Water Pumps:

According to an embodiment, it is assumed that no flow modulating valves are provided to condenser water pipes, and energy models of condenser water pumps are a modified physical model. Performance characteristic collected for the cooling water pump includes:

condenser water flow rate, Q_{cw};

Energy models of condenser water pumps are established by:

Acquire condenser water pump power by using condenser water flow rate as an independent variable, which leads to a condenser water pump power function. The function is denoted as ƒ₅ (Q_{cw}), wherein ƒ₅ (Q_{cw}) is a polynomial about Q_{cw}, wherein each item in the polynomial is composed of an n-degree term of Q_{cw}, or a constant.

Acquire correction value of condenser water pump power by using condenser water flow rate as an independent variable, which leads to a condenser water pump power correction function. The function is denoted as ƒ₆(Q_{cw}), wherein ƒ₆(Q_{cw}) is also a polynomial about Q_{cw}, wherein each item in the polynomial is composed of an n-degree term of Q_{cw}, or a constant, ƒ₆(Q_{cw}) further includes a modification constant.

Acquire condenser water pump power W_{cwe} as:

W_{cwe}=condenser water pump power×correction value of condenser water pump power, denoted as: W_{cwe}=ƒ₅(Q_{cw})ƒ₆(Q_{cw})∘

### Chilled Water Pumps

According to an embodiment, it is assumed that the chilled water pump is VSD-controlled according to differential pressure signals from differential pressure sensors that are installed between main supply and return chilled water pipes. Energy models of chilled water pumps are a modified physical model. Performance characteristic collected for chilled water pumps includes:

chilled water flow rate, Q_{chw};

Energy models of chilled water pumps are established by:

Acquire chilled water pump power by using chilled water flow rate as an independent variable, which leads to a chilled water pump power function. The function is denoted as ƒ₇(Q_{chw}), wherein ƒ₇(Q_{chw}) is also a polynomial about Q_{chw}, wherein each item in the polynomial is composed of an n-degree term of Q_{chw}, or a constant.

Acquire correction value of chilled water pump power by using chilled water flow rate as an independent variable, which leads to a chilled water pump power correction function. The function is denoted as ƒ₈(Q_{chw}), wherein ƒ₈(Q_{chw}) is also a polynomial about Q_{chw}, wherein each item in the polynomial is composed of an n-degree term of Q_{chw}, or a constant, ƒ₈(Q_{chw}) further includes a modification constant.

Acquire chilled water pump power W_{chwe} as:

W_{chwe}=chilled water pump power×correction value of chilled water pump power, denoted as: W_{chwe}=ƒ₇(Q_{chw})ƒ₈(Q_{chw}).

### Cooling Towers

Performance characteristic collected for cooling tower fans includes:

rated input power of cooling tower fan, P;

Energy models of cooling tower fans are established by:

Acquire cooling tower fan power by using rated input power of cooling tower fans as an independent variable, which leads to a power function of cooling tower fans. The function is denoted as ƒ₉(P), wherein ƒ₉(P) is a polynomial about P, wherein each item in the polynomial is composed of an n-degree term of P with a regression coefficient, or a constant.

Acquire correction value of cooling tower fan power by using rated input power of cooling tower fans as an independent variable, which leads to a correction function cooling tower fan power. The function is denoted as ƒ₁₀(P), wherein ƒ₁₀(P) is a polynomial about P, wherein each item in the polynomial is composed of an n-degree term of P with a regression coefficient, or a constant.

Obtain actual power of the fan for cooling tower W_{tower} as:

W_{tower}=power of cooling tower fan×correction value of cooling tower fan power, denoted as: W_{tower}=ƒ₉(P)ƒ₁₀(P).

Considering actual application, performance models of cooling towers are further established based on the following assumptions:

1) air and water vapor being ideal gases;

2) entering flow rate of cooling towers equaling to leaving flow rate of cooling towers;

3) heating generated by cooling tower fans being ignored;

4) air films contacting the water vapor being saturated;

5) ratio of thermal mass transfer coefficients—Lewis coefficient being 1;

Establishment of t performance models of cooling towers includes: performing off-line computation for performance models of cooling towers, including:
collecting basic cooling tower parameters, such as outdoor air wet bulb temperature under rated conditions, t_{wbin0}, entering condenser water temperature of cooling towers under rated conditions, t_{win0}, leaving condenser water temperature of cooling towers under rated conditions, t_{wout0}, heat extraction rate of cooling towers under rated conditions, P_{tower0}, cooling tower air flow rate under rated conditions, Mₐ₀, cooling tower water flow rate under rated conditions, M_{w0};
computing cooling tower heat transfer capacity based on basic cooling tower parameters;
Acquiring operation parameters under different working conditions by cooling tower off-line computation, wherein operation parameters include entering condenser water temperature of cooling towers, t_{win0}, leaving condenser water temperature of cooling towers, t_{wout0}, cooling tower heat extraction rate, P_{tower0}, cooling tower air flow rate, Mₐ₀, cooling tower water flow rate, M_{w0};
constructing performance models of cooling towers for on-line computation; performing on-line computation, including:
computing, by using performance models of cooling towers obtained by off-line computation, entering condenser water temperature t_{win} and flow rate M_{w} for a single cooling tower under current working conditions based on heat extraction rate of a single cooling tower Pₜᵢ, leaving condenser water temperature t_{wout}, and outdoor air wet bulb temperature, t_{wbin0}, wherein t_{win} and M_{w} are denoted as:

t_{win}=θ(Pₜᵢ,t_{wout},t_{wbin})

M_{w}=F(Pₜᵢ,t_{wout},t_{wbin})

According to embodiments of the present invention, the global efficiency of a chiller plant system is optimized by adjusting working conditions of each piece of equipment in consideration of a group of parameters such as chiller cooling capacity, chilled water supply temperature and flow rate, entering condenser water temperature, and working conditions of cooling towers.

The previous description of the disclosed embodiments is provided to enable any person skilled in the art to make or use the present invention. Various modifications to these embodiments will be readily apparent to those skilled in the art and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of energy-efficient control for central chiller plant systems, comprising:
collecting performance characteristics of each piece of equipment in the central chiller plant systems, and establishing energy models for each piece of equipment according to the performance characteristics;
sampling, with a predetermined time interval, the actual cooling load of the central chiller plant systems, and computing optimized system working conditions based on the actual cooling load and energy models of each piece of equipment, wherein the optimized system working conditions ensure the lowest global energy consumption of all equipment in the central chiller plant systems;
adjusting working conditions for each piece of equipment according to the optimized system working conditions; and
repeating steps of collecting, sampling and adjusting.

2. The method of claim 1, wherein at least one of the central chiller plant systems comprises chillers, and the performance characteristics collected for the chillers comprises one or more of:
chilled water supply temperature, t_{chws};
entering condenser water temperature of water-cooled chillers;
outdoor air dry bulb temperature of air-cooled chillers, t_{cws/oat};
chiller cooling capacity, Q;
rated capacity of chillers under typical evaporating and condensing temperature, Q_{ref}; and
input power under typical evaporating and condensing temperature, P_{ref}.

3. The method of claim 1, wherein at least one of the central chiller plant systems comprises cooling water pumps, and the performance characteristic collected for cooling water pumps comprises:
condenser water flow rate, Q_{cw};
wherein the method further comprises establishing energy models of condenser water pumps based on the assumption that no flow modulating valves are provided to condenser water pipes of the central chiller plant systems, wherein establishing energy models comprises:
acquiring condenser water pump power by using condenser water flow rate as an independent variable;
acquiring a correction value of condenser water pump power by using condenser water flow rate as an independent variable; and
acquiring condenser water pump power W_{cwe} as:
W_{cwe}=condenser water pump power×correction value of condenser water pump power.

4. The method of claim 1, wherein at least one of the central chiller plant systems comprise chilled water pumps, and the performance characteristic collected for chilled water pumps comprises:
chilled water flow rate, Q_{chw};
wherein the method further comprises establishing energy models of chilled water pumps based on the assumption that chilled water pumps are VSD-controlled according to differential pressure signals from differential pressure sensors that are installed between a main supply and return chilled water pipes of the central chiller plant systems, wherein establishing energy models comprises:
acquiring chilled water pump power by using chilled water flow rate as an independent variable;
acquiring a correction value of chilled water pump power by using chilled water flow rate as an independent variable;
acquiring chilled water pump power W_{chwe} as:
W_{chwe}=chilled water pump power×correction value of chilled water pump power.

5. The method of claim 1, wherein at least one of the central chiller plant systems comprises cooling towers, and the performance characteristic collected for cooling towers comprises:
rated input power of cooling tower fans, P;
wherein the method further comprises establishing energy models of cooling tower fans, comprising:
acquiring cooling tower fan power by using rated input power cooling tower fans as an independent variable;
acquiring a correction value of cooling tower fan power by using rated input power of cooling tower fans as an independent variable; and
acquiring actual power of cooling tower fans W_{tower} as:
W_{tower}=power of cooling tower fans×correction value of cooling tower fan power;
wherein the method further comprises establishing performance models of cooling towers based on one or more of the following assumptions:
air and water vapor being ideal gases;
entering condenser water flow rate of cooling towers equaling to leaving condenser water flow rate of cooling towers;
heating generated by cooling tower fans being ignored;
air films contacting the water vapor being saturated;
ratio of thermal mass transfer coefficients—Lewis coefficient being 1;
wherein establishing performance models of cooling towers comprises:
performing off-line computation for cooling towers performance models, including:
collecting basic cooling tower parameters, such as outdoor air wet bulb temperature under rated working conditions, t_{wbin0}, entering condenser water temperature of cooling towers under rated working conditions, t_{win0}, leaving condenser water temperature of cooling towers under rated working conditions, t_{wout0}, heat extraction rate of cooling towers under rated working conditions, P_{tower0}, cooling tower air flow rate under rated working conditions, Mₐ₀, cooling tower water flow rate under rated working conditions, M_{w0};
computing cooling tower heat transfer capacity based on basic cooling tower parameters;
acquiring operation parameters under different working conditions by cooling tower off-line computation, wherein operation parameters includes entering condenser water temperature of cooling towers, t_{win0}, leaving condenser water temperature of cooling towers, t_{wout0}, cooling tower heat extraction rate, P_{tower0}, cooling tower air flow rate, Mₐ₀, cooling tower water flow rate, M_{w0};
constructing performance models of cooling towers for on-line computation; and
performing on-line computation, including:
computing, by using working condition models of cooling towers obtained by off-line computation, entering condenser water temperature t_{win} and cooling water flow rate M_{w} for a single cooling tower under current working conditions based on heat extraction rate of a single cooling tower Pₜᵢ, leaving condenser water temperature t_{wout}, and outdoor air wet bulb temperature, t_{wbin0}.

6. An energy-efficient control system for central chiller plant systems, comprising:
a central PC, configured to collect performance characteristics of each piece of equipment in a central chiller plant system;
a plurality of Programmable Logic Controllers (PLCs), each connected to one or more groups of equipment in the central chiller plant systems, and configured to control connected equipment;
energy modeling, configured to establish energy models for each piece of equipment according to their performance characteristics and to store energy models in a model database;
wherein the central PC is configured to sample the actual cooling load of a central chiller plant system with a predetermined time interval, compute optimized system working conditions based on the actual cooling load and energy models of each piece of equipment stored in the model database, and wherein the optimized system working conditions ensure the lowest overall energy consumption of all equipment in the central chiller plant system; and
wherein each PLC is configured to adjust the working conditions for equipment controlled by the PLC in accordance with the optimized system working conditions.

7. The system of claim 6, wherein the energy modeling is configured to establish energy models of chillers, and wherein the performance characteristics collected by the central PC comprises one or more of:
chilled water supply temperature, t_{chws};
entering condenser water temperature of water-cooled chillers;
outdoor air dry bulb temperature of air-cooled chillers, t_{cws/oat};
chiller cooling capacity, Q;
rated capacity of chillers under typical evaporating and condensing temperature, Q_{ref}; and
input power under typical evaporating and condensing temperature, P_{ref}.

8. The system of claim 6, wherein the energy modeling is configured to establish energy models of condenser water pumps, and wherein the performance characteristics collected by the central PC comprises:
condenser water flow rate, Q_{cw};
wherein energy modeling is configured to establish energy models of cooling water pumps based on the assumption that no flow modulating devices are provided to condenser water pipes of the central chiller plant systems, wherein establishing energy models comprises:
acquiring condenser water pump power by using condenser water flow rate as an independent variable;
acquiring a correction value of condenser water pump power by using condenser water flow rate as an independent variable; and
acquiring condenser water pump power W_{cwe} as:
W_{cwe}=condenser water pump power×correction value of condenser water pump power.

9. The system of claim 6, wherein energy modeling is configured to establish energy models of chilled water pumps, and wherein the performance characteristics collected by the central PC comprises:
chilled water flow rate, Q_{chw};
wherein the system further comprises energy models of chilled water pumps based on the assumption that chilled water pumps are VSD-controlled according to differential pressure signals from differential pressure sensors that are installed between a main supply and return chilled water pipes, wherein the energy models are established by:
acquiring chilled water pump power by using chilled water flow rate as an independent variable;
acquiring a correction value of chilled water pump power by using chilled water flow rate as an independent variable; and
acquiring chilled water pump power W_{chwe} as:
W_{chwe}=chilled water pump power×correction value of chilled water pump power.

10. The system of claim 6, wherein energy modeling is configured to establish energy models of cooling towers, and wherein the performance characteristics collected by the central PC comprises:
rated input power of cooling tower fans, P;
wherein the system further comprises energy models of cooling tower fans, comprising:
acquiring cooling tower fan power by using rated input power cooling tower fans as an independent variable;
acquiring a correction value of cooling tower fan power by using rated input power of cooling tower fans as an independent variable; and
acquiring actual power of cooling tower fans W_{tower} as:
W_{tower}=power of cooling tower fans×correction value of cooling tower fan power;
wherein the system further comprises performance models of cooling towers based on one or more of the following assumptions:
air and water vapor being ideal gases;
entering condenser water flow rate of cooling towers equaling to leaving condenser water flow rate of cooling towers;
heating generated by cooling tower fans being ignored;
air films contacting the water vapor being saturated;
ratio of thermal mass transfer coefficients—Lewis coefficient being 1;
wherein establishing performance models of cooling towers comprises:
performing off-line computation for cooling towers performance models, including:
collecting basic cooling tower parameters, such as outdoor air wet bulb temperature under rated working conditions, t_{wbin0}, entering condenser water temperature of cooling towers under rated working conditions, t_{win0}, leaving condenser water temperature of cooling towers under rated working conditions, t_{wout0}, heat extraction rate of cooling towers under rated working conditions, P_{tower0}, cooling tower air flow rate under rated working conditions, Mₐ₀, cooling tower water flow rate under rated working conditions, M_{w0};
computing cooling tower heat transfer capacity based on basic cooling tower parameters;
acquiring operation parameters under different working conditions by cooling tower off-line computation, wherein operation parameters includes entering condenser water temperature of cooling towers, t_{win0}, leaving condenser water temperature of cooling towers, t_{wout0}, cooling tower heat extraction rate, P_{tower0}, cooling tower air flow rate, Mₐ₀, cooling tower water flow rate, M_{w0};
constructing performance models of cooling towers for on-line computation; and
performing on-line computation, including:
computing, by using working condition models of cooling towers obtained by off-line computation, entering condenser water temperature t_{win} and cooling water flow rate M_{w} for a single cooling tower under current working conditions based on heat extraction rate of a single cooling tower Pₜᵢ, leaving condenser water temperature t_{wout}, and outdoor air wet bulb temperature, t_{wbin0}.

11. The method of claim 2 further comprising establishing energy models of the chillers by a regression computation based on the performance characteristics, wherein the number and type of the performance characteristics collected for the chillers comprises those necessary for establishing energy models, wherein establishing energy models comprises:
acquiring a first function based on t_{chws} and t_{cws/oat};
acquiring a second function based on t_{chws} and t_{cws/oa};
acquiring a fourth function based on Q, Q_{ref} and the first function;
acquiring a third function based on the fourth function; and
acquiring an input power of chillers P as:
P=P_{ref}×the first function×the second function×the third function.

12. The control system of claim 6, wherein the PLCs are connected to the central PC via industrial Ethernet.

13. The control system of claim 7, wherein the energy models of the chillers are derived by a regression computation based on the performance characteristics, wherein the number and type of the performance characteristics collected for the chillers comprises those necessary for establishing the energy models of the chillers, wherein establishing the energy models comprises:
acquiring a first function based on t_{chws} and t_{cws/oat};
acquiring a second function based on t_{chws} and t_{cws/oa};
acquiring a fourth function based on Q, Q_{ref} and the first function;
acquiring a third function based on the fourth function; and
acquiring an input power of chillers P as:
P=P_{ref} ×the first function×the second function×the third function.
